(19) United States
(12) Patent Application Publication
(10) Pub. No.: US 2006/0073464 A1
(43) Pub. Date: Apr. 6, 2006

(54) Location determinative electronic training methodology and related architecture

(76) Inventors: Ronald F. Baldus, Camas, WA (US); Steven A. Fain, Vancouver, WA (US); Randall T. Kohltfarber, Camas, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/943,368

(22) Filed: Sep. 17, 2004

(51) Int. Cl. G09B 3/00

(52) U.S. Cl. 434/350; 434/362

(57) ABSTRACT

Embodiments of the present invention involve a location-determinative training and verification methodology including supporting architecture designed to allow users to travel to and identify elements of a training process or work flow.

### BACKGROUND OF THE INVENTION

1. Field of the Invention

The present invention relates generally to the field of electronic training systems. More specifically, the present invention relates to a location-determinative electronic training system and related methods.

2. Background Information

Computer based training (CBT) generally describes a mode of self-paced or instructor-led education whereby electronic coursework is provided to and performed by students via a computer. The electronic coursework, often referred to as courseware, may be provided to students via a wide variety of media such as CD-ROMs and Digital Versatile Disks (DVDs), or over a network connection.

Computer based training systems vary from one implementation to another, but can typically include a number of software modules/components as well as a variety of computing devices. In particular, a typical computer based training system may include a CBT publisher, a learning management system (LMS), a web server and one or more client computers used to access prescribed coursework.

The CBT publisher may be used to create customized computer based curriculums and make such curriculums available to one or more students. Such computer based curriculums may contain any combination of text and visual aides such as audio and video content to increase the ease of use and/or pedagogical impact of the coursework. Additionally, computer based training coursework may be integrated with questions or formal examinations so as to reinforce the learning process.

Learning management systems typically include a central data repository that is used to track students' individual progress and test scores throughout the CBT coursework. The CBT coursework may be organized into a hierarchical topology where one up to many CBT courses constitutes a learning unit. Subsequently, one to many learning units may be grouped into another higher level of learning and so forth. The learning management system may then be used to manage the CBT coursework, and unit fulfillment. Depending again upon implementation, students may be determined to have completed a course or unit through either testing (electronic or written) or oral examination.

This computerized training is typically done in a classroom or extended classroom (e.g. home) environment where the testing methodology is non-portable. A student's skill base is most often determined by the number of correct answers provided, and students are determined to have ‘passed’ if the number of correct answers provided is equal to and/or greater than a preset number or percentage.

However, this methodology does not allow the student to be tested on their ability to travel to and identify a specific portion of a process or a specified process element for example.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of a training and verification system according to one embodiment of the present invention;

FIG. 2 illustrates an example process for defining location based tasks in accordance with one embodiment of the invention;

FIG. 3 illustrates an example operational flow from the perspective of a portable training and verification device in accordance with one embodiment of the invention;

FIG. 4 illustrates an operational flow for determining whether a task is successfully performed in accordance with one embodiment of the invention;

FIG. 5 illustrates an operational flow for comparing input data with stored data in accordance with one embodiment of the invention;

FIG. 6 illustrates an operational flow for determining whether a task is successfully performed in accordance with an alternative embodiment of the invention;

FIGS. 7A and 7B illustrate example data structures and corresponding member variables for use in embodiments of the present invention;

FIG. 8 illustrates an example processing system suitable for use as PTVD 140 in practicing embodiments of the present invention; and

FIG. 9 illustrates a portable training and verification device in accordance with one embodiment of the present invention.

### DETAILED DESCRIPTION OF EMBODIMENTS OF THE INVENTION

In the description to follow, various aspects of the present invention will be described, and specific configurations will be set forth. However, the present invention may be practiced with only some or all aspects, and/or without some of these specific details. In other instances, well-known features are omitted or simplified in order not to obscure the present invention.

The description will be presented in terms of operations performed by a processor based device consistent with the manner commonly employed by those skilled in the art to convey the substance of their work to others skilled in the art. As is well understood by those skilled in the art, the quantities take the form of electrical, magnetic, or optical signals capable of being stored, transferred, combined, and otherwise manipulated through mechanical, electrical and/or optical components of the processor based device.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous.

Configuration Overview

Embodiments of the present invention involve a location-determinative training and verification methodology including supporting architecture designed to allow users to travel to and identify elements of a training process or work flow. In one embodiment, elements such as components, stages of a process, locations involved in a process, and so forth, can be identified by their physical location in a process or by measure of their current value or reading. By transporting the conventional classroom-based computer based training (CBT) program into a physical process and out of the classroom, an individual's knowledge of the entire process can be enhanced and perceived learning curves reduced. For the purposes of this disclosure, the acronym “CBT” is intended to encompass all forms of technology based training including, but not limited to web-based training (WBT) and interactive multimedia training. Furthermore, the term multimedia is intended to broadly refer to a wide variety of media including text, graphics, animations, audio, video and combinations thereof, whether in digital, analog or mixed formats.

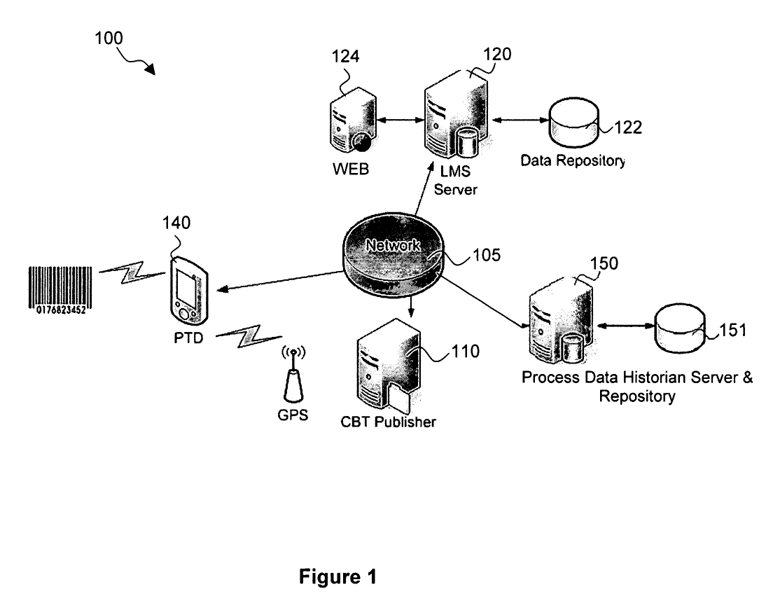

FIG. 1 illustrates an overview of a training system according to one embodiment of the present invention. As shown, enhanced CBT system 100 includes portable training and verification device (PTVD) 140 of the present invention communicatively coupled to CBT publisher 110, learning management system (LMS) 120, and process data historian 150 via network 105.

Network 105 may represent one or more of a broad range of communication networks to facilitate data communications between devices such as PTVD 140, publisher 110, learning management system (LMS) 120, and process data historian 150. In particular, network 105 may represent a local area network, wide area network, the Internet, the World Wide Web, and the like, whether packet switched or not.

Publisher 110 may represent a CBT authoring system to support trainers and developers in producing or editing interactive courseware. Publisher 110 may provide developers with facilities to create or author various training modules or CBT units which may include content, question sets, and graphical user interfaces that may accompany such CBT units. In accordance with one embodiment of the invention, publisher 110 may provide facilities for courseware authors to design and/or identify one or more task lists containing one or more tasks to be performed by a user in association with a CBT unit.

LMS 120 may represent a server equipped to manage the presentation of CBT coursework to users as well as manage the tracking and reporting of user progress in performance of such coursework. LMS 120 may include one or more data repositories 122 to track and store user's individual progress and test scores associated with CBT coursework. LMS 120 may further include a presentation server such as web server 124 to provide a remotely accessible, device-independent interface through which users and teachers alike may access coursework, including content, questions, and statistics via network 105. In accordance with one embodiment of the present invention, LMS 120 and data repository 122 may be adapted to present and manage coursework containing task-based CBT units in which successful user performance of tasks may be location-dependent. That is, in one embodiment users may be requested to physically locate and/or identify one or more elements of a process in order to successfully perform a task. For the purpose of this disclosure, unless otherwise indicated, the term “process” is intended to broadly refer to any method or system of doing something, producing something, or accomplishing a specific result, and may include a work flow. In one embodiment, a process may be deconvolved into constituent elements (e.g. by a trainer or CBT developer) and the elements or attributes of such elements may be stored within data repository 122 in association with one or more identifiers. In one embodiment, unique identifiers and corresponding process elements may be stored in a lookup table for use in determining whether a user has successfully located and/or identified a given task element. In one embodiment, such identifiers may include, but are not limited to universal product code (UPC) data associated e.g. with barcodes, geographical coordinates such as longitude, latitude, and altitude/elevation (or combinations thereof), radio frequency ID tag data, and so forth.

Process data historian 150 may represent (along with data repository 151) a server or application equipped to facilitate the capture, storage, analysis and visualization of both real time and asynchronous process data associated with one or more processes or process elements.

PTVD 140 may represent a portable training and verification device adapted to facilitate portable, location-determinative electronic training and/or task verification. In one embodiment, PTVD 140 may be equipped to present (whether visually or audibly) one or more location-dependent training tasks to a user and to receive input data to facilitate determining successful or unsuccessful performance of a given task by the user. In one embodiment, PTVD 140 may present a request to a user to physically locate a target element defined as being part of a given process. In another embodiment, PTVD 140 may be equipped to present one or more verification tasks to a user to facilitate in measuring a process' or workflow's known standard operating procedure(s). In one embodiment, PTVD 140 may be equipped to receive (whether manually or automatically without user intervention) input data representing a value or measurement associated with a process element.

In one embodiment, PTVD 140 may be equipped to receive input data that uniquely identifies either the location of PTVD 140 or a located element proximate to PTVD 140. The data may be manually entered by the user or automatically detected by the PTVD. In turn, the physical proximity of PTVD 140 determined with respect to either the target element or the located element may be determined. In one embodiment, input data received by PTVD 140 may take the form of a wide variety of data types including, but not limited to, universal product code (UPC) data associated with e.g. barcodes, geographical coordinates such as longitude, latitude, and altitude/elevation (or combinations thereof), radio frequency ID tag data, process values obtained from a located element and the like. Additionally, input data received by PTVD 140 may take the form of an input pulse or interrupt resulting e.g. from the press of a button or key associated with PTVD 140. In one embodiment, in order to successfully perform a presented task, a user may be required to physically travel to a location (whether e.g. in a given structure or locality) and locate a particular target element. In one embodiment, a user may indicate detection of a located element that the user presumes to be the target element through provision of the input data to PTVD 140. For example, a user may indicate detection of a located element to PTVD 140 through activation of a physical or graphical button or icon, provision of alphanumeric or voice data, provision of optically or electronically scanned data such as barcode data or radio frequency identification tag data, or through reception of a terrestrial or satellite based signal, to name just a few.

Operational Overview

The electronic training and verification methodology of the present invention may include a task definition phase and a task performance phase. The task definition phase typically may take place prior to the task performance phase and may involve a content publisher, developer, teacher or other party identifying a process and defining one or more locatable elements of the process or stages associated with the process. Such information may be stored within a data repository (e.g., such as data repository 122 or 151) for use in the task performance phase where, in accordance with one embodiment of the invention, one or more location-based tasks requesting the location and/or identification of the stored elements are presented to users. In one embodiment, tasks may be combined to form a task list, and task lists may be combined to form a training unit.

In one embodiment, a user may log in, authenticate or otherwise identify oneself to a task server such as LMS 120, in order to receive (whether wirelessly or otherwise) a training unit to perform. Similarly, the training unit may be loaded into PTVD 140 through a machine readable medium such as, but not limited to a floppy disk, CD-ROM, DVD, ROM, FLASH memory card, stick or drive, and so forth. Once one or more training units have been loaded into a memory of a given portable electronic device, users may be given the option of selecting the order with which tasks or task lists are performed.

In one embodiment, task lists may contain sequenced tasks designed to be performed in a predefined order. For example, an employer may wish to train an employee to perform a particular manufacturing process that involves the use of one or more devices or pieces of equipment. In designing a task list(s) to train the employee to perform this operation, the employer may wish to have the order with which tasks are presented correspond to the order of the operations to be performed as part of the manufacturing process.

In one embodiment, one or more task lists may be organized to approximate a standard operating procedure (SOP). Moreover, such SOP task lists may be presented to a user via a portable electronic device such as PTVD 140 and utilized by a user (or third party) to verify prescribed performance of one or more of the tasks. In one embodiment, the task(s) may be presented to a user in an ordered manner to measure user compliance against a process' known standard operating procedure(s). For example, a task list could be modeled after a standard operating procedure for a particular maintenance operation such as the replacement of a non-functional water pump in a manufacturing facility. A first task may be presented to a worker (e.g. via PTVD 140) indicating that the worker should locate and shut off a valve that is located upstream of the malfunctioning pump. In accordance with one embodiment of the invention, PTVD 140 may facilitate in first determining whether the maintenance worker has located the correct valve or valve control panel before presenting the worker with the next of the SOP procedures to perform. The training and verification system of the present invention may determine whether the worker has located the correct element such as the valve in any of a number of ways as e.g. described above. In accordance with one embodiment of the invention, the training and verification system may determine whether the fluid flow rate through the valve has reached zero percent or otherwise fallen below a predetermined flow rate. This measurement may be manually observed and entered as input data into PTVD 140 by the worker. Alternatively, such a measurement may be automatically determined by one or more flow sensors and reported back to e.g. process data historian 150 and data repository 151.

Additionally, PTVD 140 may be equipped to place one or more software calls to the data historian or other device to poll whether a proper condition, such as zero percent flow rate or device lock-out, has been achieved. Alternatively, the data historian could preemptively indicate to PTVD 140 when the proper condition such as flow rate has been achieved. In one embodiment, once the resulting effect of a performed task is measured and determined to fall within a prescribed margin of error with respect to an expected SOP value, PTVD 140 may present the next sequential task to the worker. For instance, in the example above, the next sequential task may be for the worker to actually remove the malfunctioning pump.

Although in certain embodiments tasks may be presented in an ordered manner, in other embodiments tasks may be presented to users in a randomized order. This may be desirable in cases where for example, memorization of task order may not be desirable.

In one embodiment, users may be provided with feedback indicating whether their attempted performance of a task was successful or unsuccessful. Such feedback may be provided to users either after one or more attempts have been made to perform a given task, or after a determined number of tasks have been attempted. For example, upon being requested to locate and/or identify a target element associated with a given process, a user may travel to what they believe is the target element and provide input data to the PTVD indicating a located element or value obtained from a located element. In one embodiment, a determination as to whether the task was successfully or unsuccessfully performed by the user may be made at that time. Alternatively, a determination as to whether one task was performed successfully may be only provided after one or more additional tasks have been performed by a user.

In one embodiment, the PTVD itself may make the determination as to whether a user has successfully or unsuccessfully performed a task. In another embodiment, the PTVD may transmit user answers to a server, such as LMS 120 or process data historian 150, which may then make the determination. Results of such a server-based determination may be delivered to the PTVD for presentation to the user. For example, in the event the PTVD determines whether a user has successfully or unsuccessfully performed a task, expected or otherwise acceptable answers to tasks may be provided to the PTVD in addition to the tasks themselves. One potential concern with this method may be that the user may purposely or inadvertently gain access to the answers thereby potentially causing task performance results to be skewed. Of course, the answers could be encrypted or otherwise obfuscated, however this may require the PTVD to be equipped with additional hardware or software. In the event the server determines whether a user has successfully or unsuccessfully performed a task, the PTVD may package a user's response(s) into one or more electronic messages and deliver the response(s) to the server where the determination may be made. In various embodiments, the PTVD may further insert various manifestations of meta-data into such electronic messages to provide further criteria for the server to use in determining whether a user was successful or not. For example, the PTVD may gather additional meta-data during performance of a task list, such as but not limited to, GPS coordinates recorded throughout the task list cycle along with the time the coordinates were captured so that the path of the user can be determined.

As previously indicated, the determination of whether a user has successfully performed a given task may be made in a number of manners. In one embodiment, determinations may be made based upon received input data where the input data may act to indicate that a user has located an element or may act to identify (whether directly or indirectly) the located item itself. In the former case, the user may indicate to the PTVD that the user is located proximate to the located item. The PTVD may determine the PTVD's own (and by extension, the located element's) geographical location/position and compare this information with an expected location previously associated with the target element (e.g., as may be stored in data repository 122). A determination as to whether the user successfully performed the task may then be made based upon whether the PTVD location and expected location (e.g., of the target element) fall within a determined margin or error. In the latter case where the input data may act to identify the located item, a comparison may be made between the input data and one or more identifiers previously associated with the target element. A determination as to whether the user successfully performed the task may then be made based upon whether the input data and the data stored in association with the target element fall within a determined margin or error. For example, a user may locate a process element and scan a corresponding barcode tag affixed to the element or located proximate to the element. If the scanned barcode data matches barcode data previously associated with the target element, the user may be deemed to have performed the task successfully. However, in certain cases, a user may be allowed to locate any one of multiple elements, where e.g., allowable elements may be indicated by a range of acceptable values.

Additionally, a determination as to whether the user successfully performed the task may be made based upon the amount of time it takes a user to locate and/or identify a target element. For example, as a task is presented to a user, a timer may be started by the PTVD to track the amount of time it takes for a user to locate an element (e.g., as described above). The determination as to whether the user successfully performed the task may then be made based at least in part upon whether the amount of time it took the user to locate and/or identify the target element falls within a margin of error that has been determined to be acceptable.

Task Definition Process

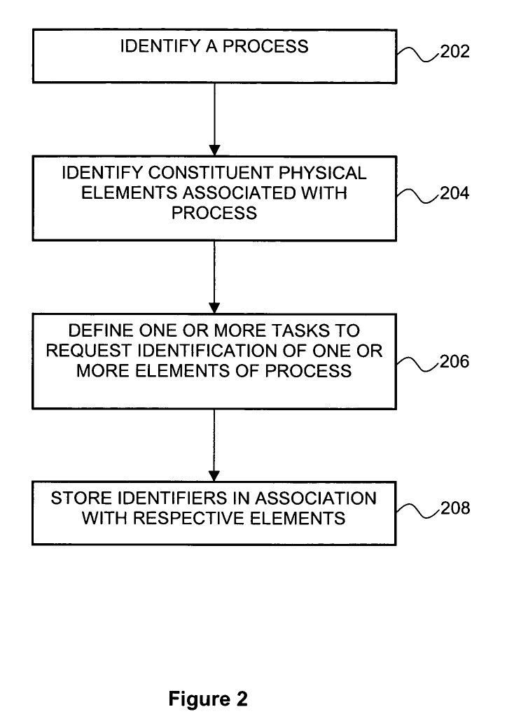

FIG. 2 illustrates an example process for defining location based tasks in accordance with one embodiment of the invention. At block 202, a process may be identified for which a training unit or module is to be designed. At block 204, one or more constituent physical elements may be identified as being associated with the process. At block 206, one or more tasks may be defined such that when presented to a user, the user is prompted to physically locate a target element associated with the process. At block 208, identifiers may be stored (e.g., in data repository 122) in association with respective process elements to facilitate identification of the elements. The process depicted in FIG. 2 may be practiced through the execution of one or more programming instructions by publisher 110 or LMS 120. Alternatively, publisher 110 and LMS 120 may each perform a portion of the process of FIG. 2.

Training Process

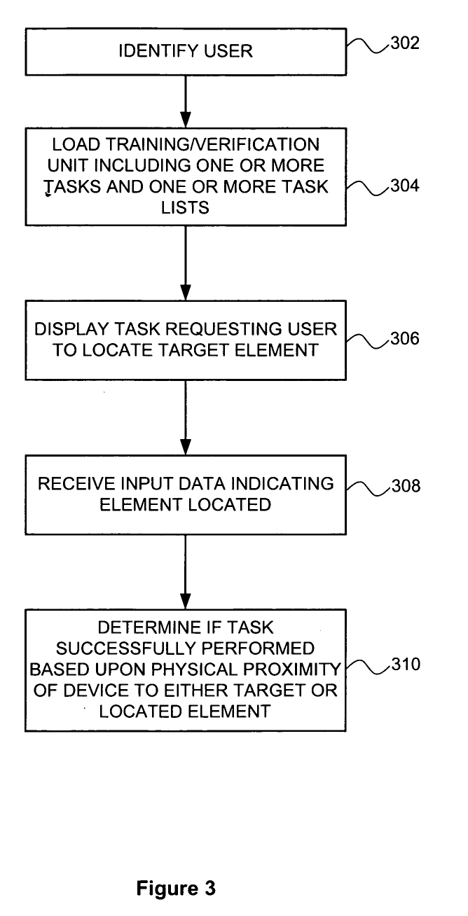

The training process of the present invention may proceed in a variety of ways depending upon the specific system implementation. FIG. 3 illustrates an example operational flow from the perspective of a portable training and verification device in accordance with one embodiment. In the embodiment illustrated in FIG. 3, the process begins at block 302 with a user who intends to participate in a training session being identified by one or more devices within the training system. In one embodiment, the user may log in, authenticate or otherwise identify oneself to PTVD 140 and/or LMS 120. For example, using PTVD 140, a user may access a client training interface through PTVD 140 which may require that the user log into a preexisting account hosted or otherwise managed by LMS 120. The client training interface may represent a readily available graphical or text browser application or a software component/module custom designed to practice the teachings of the present invention. Once the user has been identified, PTVD 140 may then load an appropriate training unit containing one or more tasks in the form of one or more task lists, block 304. In one embodiment, the training unit may be delivered to PTVD 140 based at least in part upon the identity of the user. In one embodiment, users may be allowed to choose which of multiple task lists they wish to complete. Once a training unit has been loaded, a task requesting the user to locate a target element may be presented to the user as illustrated in block 306. In one embodiment the task may be visually presented to the user via e.g. a graphical display device. In other embodiments, however, the task may be aurally presented to the user using a speaker for example. At block 308, input data indicating a located element may be received by PTVD 140. The input data may be entered or otherwise generated manually by the user, or the data may be optically or electronically received by PTVD 140. At block 310, a determination is made as to whether the presented task was performed successfully by the user based upon the physical proximity of PTVD 140 to either the target or the located element.

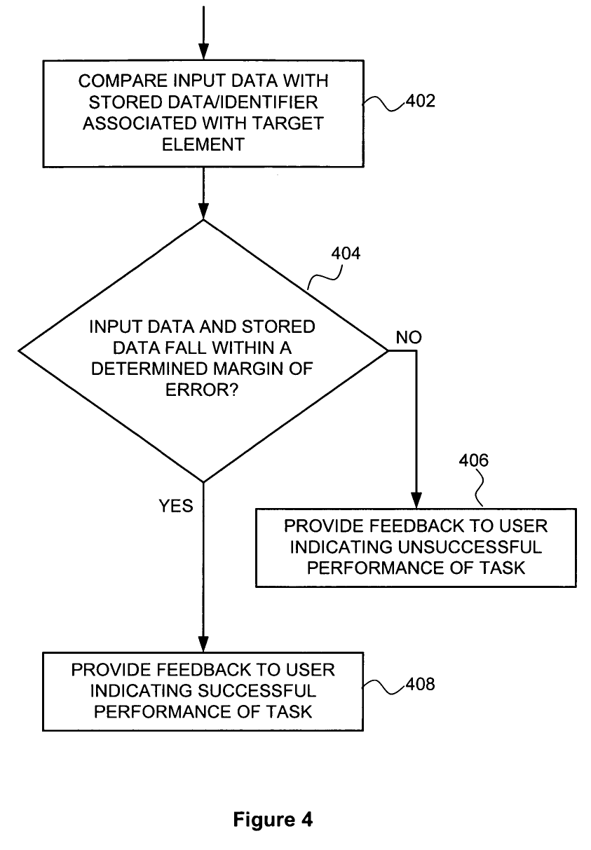

FIG. 4 illustrates an operational flow for determining whether a task is successfully performed in accordance with one embodiment of the invention. The process of FIG. 4 begins at block 402 where input data received by PTVD 140 (e.g. as represented in block 308 of FIG. 3) is compared with data stored in association with the target element. At decision block 404, a determination is made as to whether results of the comparison between the input data and the stored data fall within a determined margin of error. If so, feedback may be provided to the user indicating successful performance of the task at block 408. If the input data and the stored data do not fall within a determined margin of error however, feedback may be provided to the user indicating unsuccessful performance of the task at block 410.

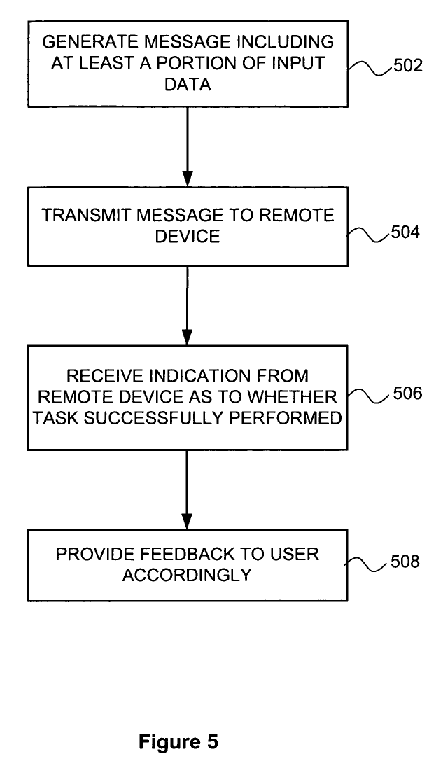

FIG. 5 illustrates an operational flow for comparing input data with stored data in accordance with one embodiment of the invention. The process of FIG. 5 begins at block 502 where PTVD 140 may generate an electronic message including at least a portion of the input data, which may then be transmitted to a remote device such as LMS 120, publisher 110, or process data historian 150, as illustrated in block 504. In one embodiment, the remote device may receive the electronic message and remotely perform (e.g. with respect to PTVD 140) a comparison between the input data and stored data as illustrated in FIG. 4. Upon making a determination as to whether the task has been performed successfully, the remote device may itself generate and transmit an electronic message to indicate to PTVD the outcome of the determination. PTVD 140 may then receive the indication from the remote device indicating whether the task was successfully performed (block 506), and provide appropriate feedback to the user accordingly as illustrated by block 508.

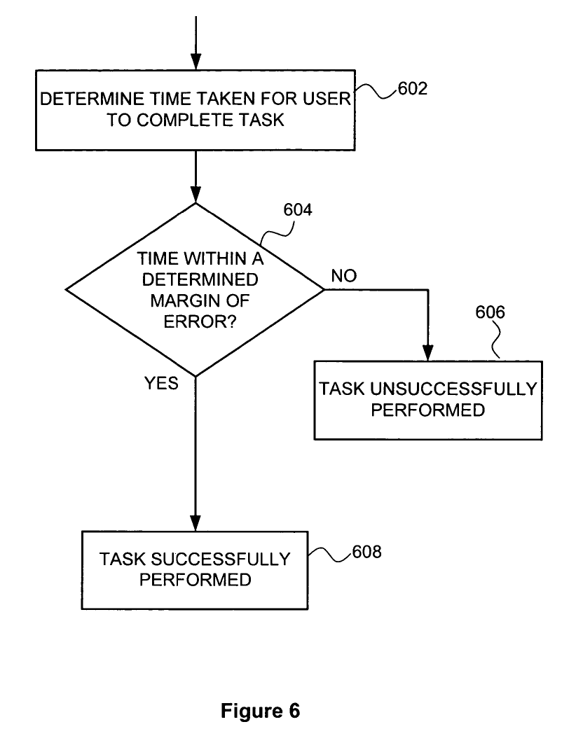

FIG. 6 illustrates an operational flow for determining whether a task is successfully performed in accordance with an alternative embodiment of the invention. The process of FIG. 6 begins at block 602 where the time that it takes the user to complete a task is determined. In one embodiment a timer may be started by PTVD 140 upon the task being displayed to the user and the timer may be stopped upon the user providing input data indicating that they have located what they presume to be a target element. At block 604, a determination may be made as to whether the time taken for the user to complete a given task falls within a determined margin of error. If so, the task may be deemed successfully performed at block 608. If, however, it is determined that the time taken for the user to complete a given task does not fall within a determined margin of error, the task may be deemed unsuccessfully performed as illustrated in block 606.

Data Structures

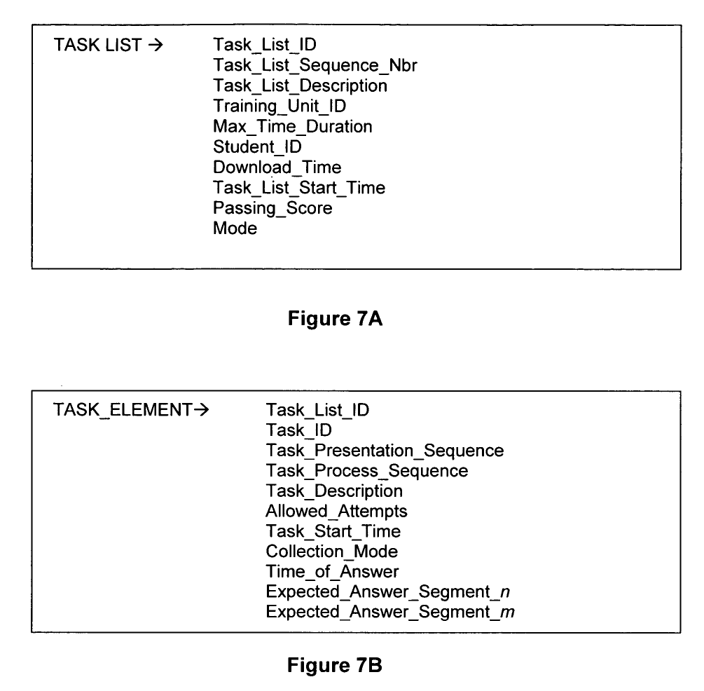

In accordance with one embodiment of the invention as described above, each task may require a user to locate one or more identified process elements in order for the task to be deemed successfully performed. One or more tasks may be combined to form a task list, while one or more task lists may be combined to form a learning unit. FIGS. 7A and 7B illustrate example data structures and corresponding member variables for use in embodiments of the present invention. More specifically, FIG. 7A illustrates a data structure containing member variables that may be used to represent a process element, whereas FIG. 7B illustrates a data structure containing member variables that may be used to represent a task list. Data may be exchanged between a PTVD and an LMS or data store in the form of an XML data stream, a flat file exchange, or via he use of a structured query language.

As shown in FIG. 7A, an exemplary task list data structure may include: a task list identifier to uniquely identify (e.g. to LMS 120) a task list to be completed; a task list sequence number to control the order with which task lists may be presented to a user in the event the PTVD contains multiple task lists; a text descriptor of the task list; a unique training unit identifier issued by the LMS for a particular training unit or course; the maximum duration allotted for a user to complete all of the tasks on a task list; a download time captured by the PTVD when the task list record is received; a start time captured by the PTVD when the first task list item is presented; the number of correct answers required for a user to successfully complete the task list; and a mode identifier to indicate whether the PTVD will inform the user of a score and whether a task list may be retried if not successful.

As shown in FIG. 7B, an exemplary task data structure may include: a task list identifier to uniquely identify (e.g. to LMS 120) a task list to be completed; a task identifier to uniquely identify a particular task within the LMS; a task presentation sequence number to influence the presentation order of tasks; a task process sequence number to represent an order with which a corresponding process is typically performed; a task descriptor to inform the user what to identify or do; a number of retries allowed of the user is unsuccessful on the first try; a start time captured by the PTVD when the task is first presented; a collection mode identifier to indicate whether a value will be manually entered, scanned, or require geographic location coordinates; and one or more expected answer segments if the operational mode requires immediate grading or to provide a range of allowable values or margin of error for an answer attempt.

Example Portable Training and Verification Device

PTVD 140 may represent a wide variety of portable electronic devices such as a personal digital assistant (PDA), a wireless phone, a tablet computing device, a laptop, palmtop, or other portable or semi-portable computing device, or any other device equipped to travel with a user from one location to another.

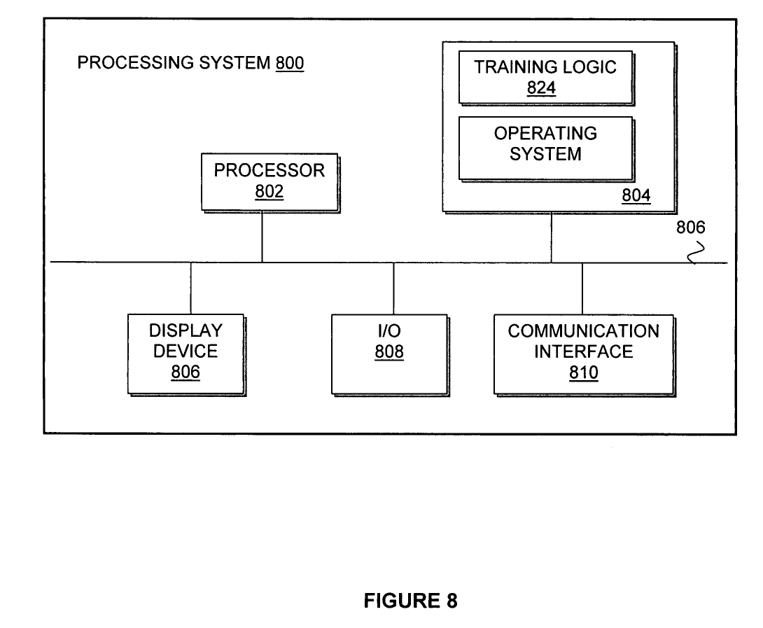

FIG. 8 illustrates an example processing system suitable for use as PTVD 140 in practicing embodiments of the present invention. As shown, example system 800 may include processor 802, system memory 804, display device 806, I/O interface 808 and communication interface 810 coupled to each other via “bus” 812.

Except for the teachings of the present invention as incorporated herein, each of these elements may represent a wide range of these devices known in the art, and otherwise performs its conventional functions. For example, processor 802 may execute programming instructions representing training logic 824 stored in memory 804, including those instructions implementing the teachings of the present invention. Memory 804 may represent non-volatile memory such as ROM, PROM, EEPROM and Flash, or memory 804 may represent volatile memory such as RAM, SDRAM, DRAM and the like. During operation, working copies of training logic 824 incorporating teachings of the present invention may be stored in RAM to facilitate location-determinative training as described herein. Alternatively, in the event memory 804 is ROM, training logic 824 may be executed in place.

Display device 806 may represent a liquid crystal display (LCD) that may be touch sensitive. I/O interface 808 may represent a number of interfaces or devices used to receive various forms of input data. For example, I/O interface 808 may represent an infrared or barcode scanning device, an RFID tag reader, a digital camera, or I/O interface 808 may represent more traditional data input devices such as a mouse, keyboard, trackball, and so forth. I/O interface 808 may further represent a GPS locator, a microphone or one or more speakers and so forth.

Communication interface 810 may represent a network communication interface to facilitate inter-device communication between e.g. PTVD 140 and one or more server devices. For example, communication interface 810 may be equipped to communicate using a variety of communication protocols including, but not limited to HTTP sockets and TCPIP sockets. Communication interface 810 may represent a modem interface, an ISDN adapter, a DSL interface, an Ethernet or Token ring network interface and the like.

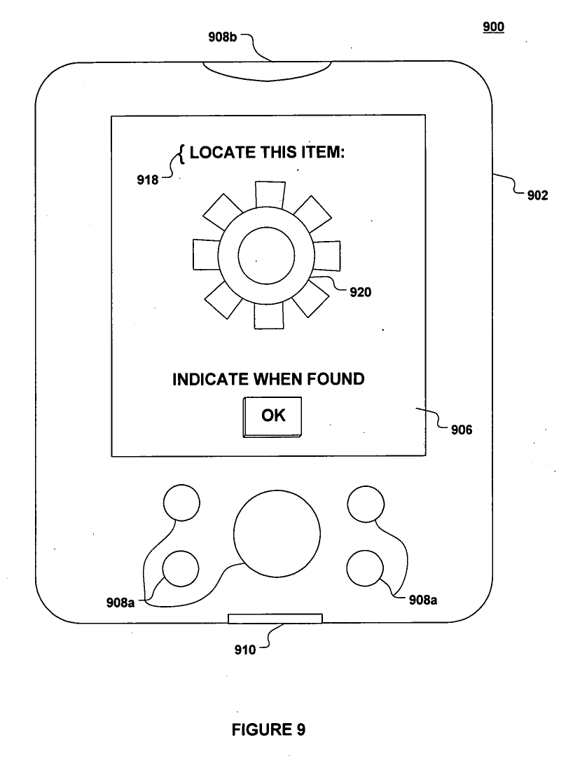

FIG. 9 illustrates one embodiment of a portable training device. PTVD 900 may include housing 902, display screen 906, I/O interface 908a and 908b, and communication interface 910. As shown, display screen 906 includes a graphical presentation of task 920 which is designed to request a user to locate an element 920 of a process in accordance with the teachings of the present invention.

Epilog

While the present invention has been described in terms of the above-illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. In a portable electronic device, a method comprising:
requesting a user to perform a first training task including identification of a target element associated with a process;
receiving input data indicating a located element; and
determining whether the first training task has been successfully performed by the user based at least in part upon physical proximity of the portable electronic device with respect to either the target element or the located element.

2. The method of claim 1, wherein the input data comprises barcode data.

3. The method of claim 1, wherein the input data comprises radio-frequency identification tag information emitted from a radio-frequency identification tag associated with the located element.

4. The method of claim 1, wherein the input data is provided by a user via a user-input device.

5. The method of claim 1, wherein determining whether the first training task has been successfully performed comprises:
comparing the input data with stored data associated with the target element; and
providing feedback to the user indicating successful performance of the first training task if differences between the input data and the stored data fall within a determined margin of error.

6. The method of claim 5, further comprising:
requesting the user to perform a second training task if it is determined that the user has successfully performed the first training task.

7. The method of claim 5, wherein comparing the input data with stored data associated with the target element comprises:
generating an electronic message including at least a portion of the input data;
transmitting the electronic message to a remote device; and
receiving an indication from the remote device as to whether the user has successfully performed the first training task.

8. The method of claim 1, wherein determining whether the first training task has been successfully performed comprises:
comparing the input data with stored data associated with the target element; and
providing feedback to the user indicating unsuccessful performance of the first training task if differences between the input data and the stored data fall outside a determined margin of error.

9. The method of claim 8, wherein receiving input data comprises receiving satellite signals to facilitate determination of a geographical location of the portable electronic device.

10. The method of claim 1, further comprising:
determining a first time at which the user is requested to perform the first training task;
determining a second time at which the input data is received; and
providing feedback to the user indicating successful performance of the first training task if differences between the first time and second time fall within a determined margin of error.

11. The method of claim 1, wherein the first training task is received from a learning management system.

12. The method of claim 1, wherein the first training task is received as part of a sequenced task list.

13. A portable electronic device comprising:
a processor; and
a machine readable medium communicatively coupled to the processor, the machine readable medium having a plurality of instructions disposed thereon, which when executed by the processor, are operative to
request a user to perform a first training task including identification of a target element associated with a process,
receive input data indicating a located element, and
determine whether the first training task has been successfully performed by the user based at least in part upon physical proximity of the portable electronic device with respect to either the target element or the located element.

14. The portable electronic device of claim 13, further comprising:
a display device coupled to the processor to request performance of one or more training tasks; and
a network interface coupled to the processor to facilitate communication between the portable electronic device and one or more stationary computing devices.

15. The portable electronic device of claim 14, further comprising:
a receiver to receive global positioning satellite signals to facilitate the portable electronic device in determining a geographic location of the portable electronic device.

16. The portable electronic device of claim 14, further comprising:
a barcode reader coupled to the processor to receive the input data.

17. The portable electronic device of claim 14, further comprising:
a radio frequency receiver to receive the input data originating from a radio frequency identification tag.

18. The portable electronic device of claim 13, wherein the portable electronic device is selected from a group consisting of a PDA, a mobile phone and a computing tablet.

19. The portable electronic device of claim 13, wherein the instructions are further operative to
compare the input data with stored data associated with the target element; and
provide feedback to the user indicating successful performance of the first training task if differences between the input data and the stored data fall within a determined margin of error.

20. The portable electronic device of claim 19, wherein the instructions are further operative to
generate an electronic message including at least a portion of the input data;
transmit the electronic message to a remote device; and
receive an indication from the remote device as to whether the user has successfully performed the first training task.

21. The portable electronic device of claim 13, wherein the instructions are further operative to
compare the input data with stored data associated with the target element; and
provide feedback to the user indicating unsuccessful performance of the first training task if differences between the input data and the stored data fall outside a determined margin of error.

22. A machine accessible medium having a plurality of processing instructions disposed thereon, which when executed by a processor, being operative to perform a method comprising:
requesting a user to perform a first training task including identification of a target element associated with a process;
receiving input data indicating a located element; and
determining whether the first training task has been successfully performed by the user based at least in part upon physical proximity of the portable electronic device with respect to either the target element or the located element.

23. The machine accessible medium of claim 22, wherein the instructions are further operative to
compare the input data with stored data associated with the target element; and
provide feedback to the user indicating successful performance of the first training task if differences between the input data and the stored data fall within a determined margin of error.

24. The machine accessible medium of claim 23, wherein the instructions are further operative to
generate an electronic message including the input data;
transmit the electronic message to a remote device; and
receive an indication from the remote device as to whether the user has successfully performed the first training task.

25. The machine accessible medium of claim 22, wherein the instructions are further operative to
compare the input data with stored data associated with the target element; and
provide feedback to the user indicating unsuccessful performance of the first training task if differences between the input data and the stored data fall outside a determined margin of error.

26. A method comprising:
transmitting a training task to a portable electronic device, the training task designed to request a user to locate a target element associated with a process;
receiving input data from the portable electronic device indicating attempted performance of the task by the user;
determining a location associated with the portable electronic device based at least in part upon the input data; and
determining whether the training task has been successfully performed by the user based at least in part upon the location of the portable electronic device.

27. The method of claim 26, wherein the input data uniquely identifies a located element, the method further comprising:
identifying within a data repository, the location of the portable electronic device based at least in part upon the received input data.

28. The method of claim 27, wherein the input data comprises barcode data.

29. The method of claim 27, wherein the input data comprises radio-frequency identification tag data.

30. The method of claim 26, further comprising:
providing a signal to the portable electronic device indicating successful performance of the first training task by the user if the determined location associated with the portable electronic device falls within a determined margin of error with respect to an expected location;

31. The method of claim 26, further comprising:
providing a signal to the portable electronic device indicating unsuccessful performance of the first training task by the user if the determined location associated with the portable electronic device falls outside of a determined margin of error with respect to an expected location;

32. The method of claim 26, further comprising:
identifying a located element based at least in part upon the location associated with the portable electronic device;
determining whether the located element is the target element; and
providing a signal to the portable electronic device indicating successful performance of the first training task by the user if the located element is the target element.

33. The method of claim 26, wherein the data is received from the portable electronic device via a communication network.

34. The method of claim 26, wherein the first training task is transmitted as part of a task list including a plurality of sequenced training tasks.

35. The method of claim 26, further comprising:
requesting the user to perform a second sequential training task if it is determined that the user has successfully performed the first training task.

36. The method of claim 26, further comprising:
determining a first time period taken by the user to perform the task;
comparing the first time period with an acceptable time period associated with the target element; and
providing feedback to the user indicating successful performance of the first training task if differences between the first time period and the acceptable time period fall within a determined margin of error.

37. An apparatus comprising:
a processor;
a network interface; and
a machine readable medium communicatively coupled to the processor, the machine readable medium having a plurality of instructions disposed thereon, which when executed by the processor, are operative to
transmit a training task to a portable electronic device, the training task designed to request a user to locate a target element associated with a process;
receive input data from the portable electronic device indicating attempted performance of the task by the user;
determine a location associated with the portable electronic device based at least in part upon the input data; and
determine whether the training task has been successfully performed by the user based at least in part upon the location of the portable electronic device.

38. The apparatus of claim 37, further comprising:
a data repository communicatively coupled to the processor, wherein the input data uniquely identifies a located element, and the instructions are further operative to
identify within the data repository, the location of the portable electronic device based at least in part upon the received input data.

39. The apparatus of claim 38, wherein the input data comprises barcode data.

40. The apparatus of claim 38, wherein the input data comprises radio-frequency identification tag data.

41. The apparatus of claim 37, wherein the instructions are further operative to
identify a located element based at least in part upon the location associated with the portable electronic device; and
determine whether the located element is the target element; and
provide a signal to the portable electronic device indicating successful performance of the first training task by the user if the located element is the target element.

42. The apparatus of claim 37, wherein the data is received from the portable electronic device via the network interface.
